(19) United States
(12) Patent Application Publication
(10) Pub. No.: US 2004/0114585 A1
(43) Pub. Date: Jun. 17, 2004

(54) Clock provisioning techniques

(76) Inventor: Finn Leif Kraemer, Naerum (DK)

Correspondence Address: Glen B. Choi, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/323,134

(22) Filed: Dec. 17, 2002

(51) Int. Cl. H04L 12/50

(52) U.S. Cl. 370/366; 370/419; 370/463; 370/535

(57) ABSTRACT

Clock provisioning techniques that may save chipset space, power, and manufacturing expense.

### FIELD

The subject matter disclosed herein generally relates to techniques to provide clock signals.

### DESCRIPTION OF RELATED ART

A transponder system can be used in an optical communications network to regenerate signals transported by the network and to prepare signals for transfer from a framer/microprocessing element to the network. For example, FIG. 1A depicts a prior art transponder 105 in block diagram form. Transponder 105 includes a serializer 120 and de-serializer 130.

Serializer 120 converts signals to be transmitted to the network from parallel format to serial format. De-serializer 130 converts signals received from the network from serial format to parallel format. Transponder 105 may interface with other network processing elements that are not depicted (such as a framer/network processing element).

A framer/network processing element (not depicted) may provide a clock signal shown as CLOCK OUT to serializer 120. Serializer 120 may use signal CLOCK OUT to time the parallel to serial format change. A framer/network processing element (not depicted) may use clock signals shown as CLOCK IN and RxMCLK from de-serializer 130 to process information from de-serializer 130.

In a physical implementation of transponder 105, a reference clock generator 110, external to transponder 105, is used to provide a clock signal TxREFCLK to the serializer 120 of transponder 105. However, reference clock generator 110 may not be provided with any physical implementation of transponder 105. Accordingly, a customer may need to separately purchase or otherwise provide the reference clock generator 110. In such scenario, one drawback with the system of FIG. 1A is the task of adding reference clock generator 110 to a customer's system is time consuming and may result in an inefficient use of chipset space.

FIG. 1B depicts in block diagram form an example of another prior art transponder in transponder 200. A physical implementation of transponder 200 may include a serializer 120, de-serializer 130, a clock signal splitter 210, and multiplexer 220. This implementation is similar to that of transponder 105 except for the use of clock signal splitter 210 and multiplexer 220.

Clock signal splitter 210 may receive a clock signal from de-serializer 130, replicate such clock signal, and transfer such clock signal (a) as clock signal CLKBRIDGE to multiplexer 220 and (b) as clock signal RXMCLK to an external framer/network processing element (not depicted).

Multiplexer 220 may select whether to transfer clock signal CLKBRIDGE or clock signal TxREFCLK (from an external reference clock generator 110, as the case may be) to serializer 120. Signal CLKBRIDGE may be used in “line timing mode” (e.g., Ethernet as described in IEEE 802.3 and related standards). Signal TxREFCLK may be used in “system timing mode” (as described, e.g., among Synchronous Optical Network (SONET) as described in ANSI T1.105, Synchronous Optical Network (SONET) Basic Description Including Multiplex Structures, Rates, and Formats; Bellcore Generic Requirements, GR-253-CORE, Synchronous Optical Network (SONET) Transport Systems: Common Generic Criteria (A Module of TSGR, FR-440), Issue 1, December 1994; and related standards).

A drawback with this implementation of transponder 200 is that additional components needed to provide splitter 210 and multiplexer 220 utilize semiconductor circuit board space, consume power, and increase the cost of transponder 200. It is desirable to minimize the amount of die space utilized, power consumed and total cost of a transponder.

### BRIEF DESCRIPTION OF THE DRAWINGS

FIGS. 1A and 1B depict a prior art communications systems in block diagram form.

FIG. 2 depicts in block diagram form a transponder, in accordance with an embodiment of the present invention.

FIG. 3 depicts a suitable implementation of a de-serializer, in accordance with an embodiment of the present invention.

FIG. 4 depicts a suitable implementation of a serializer, in accordance with an embodiment of the present invention.

Note that use of the same reference numbers in different figures indicates the same or like elements.

### DETAILED DESCRIPTION

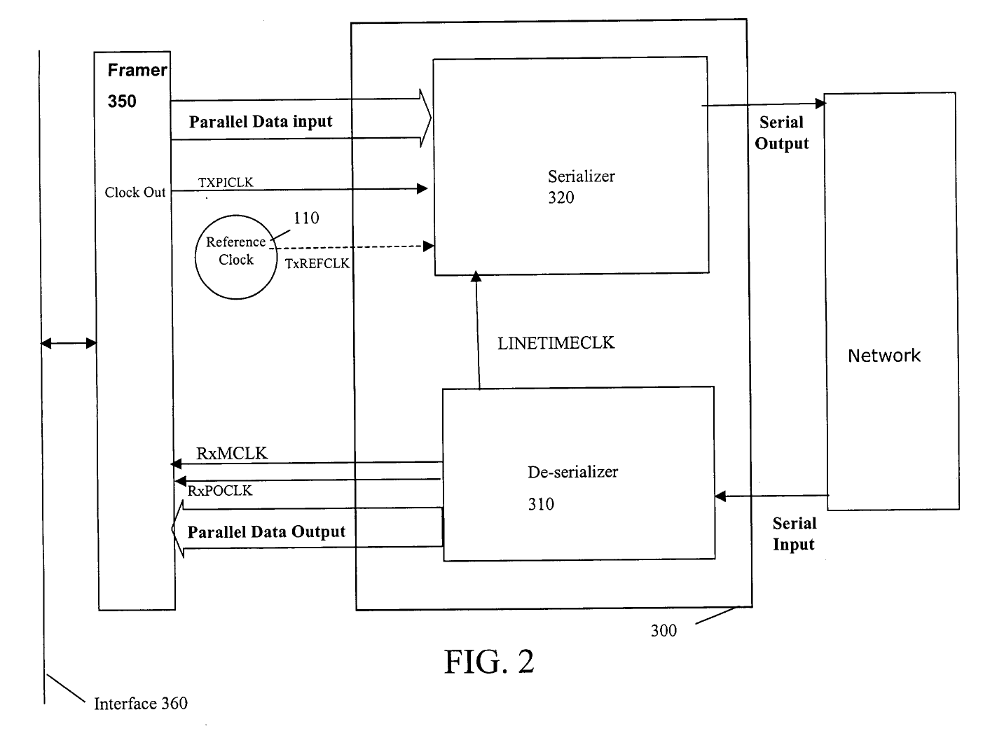

FIG. 2 depicts in block diagram form a transponder 300, in accordance with an embodiment of the present invention. One implementation of transponder 300 may include a de-serializer 310 and serializer 320. For example, a physical implementation of de-serializer 310 may provide a clock signal LINETIMECLK to serializer 320. Clock signal LINETIMECLK may be used in “line timing mode”. In one implementation, de-serializer 310 and serializer 320 may communicate using a conductive channel of a printed circuit board (not depicted) or using other signal transferring or conducting techniques.

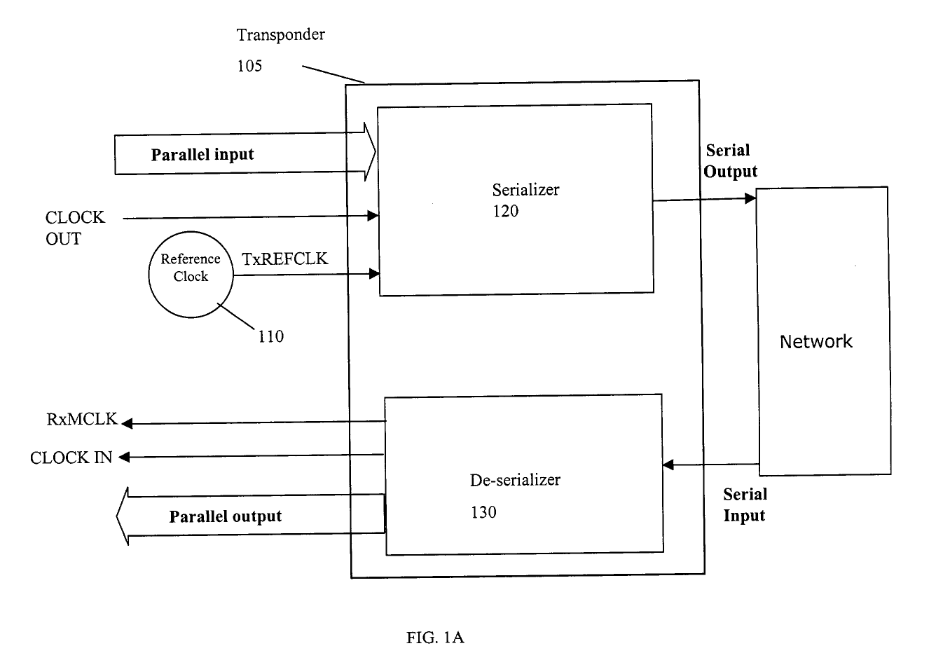

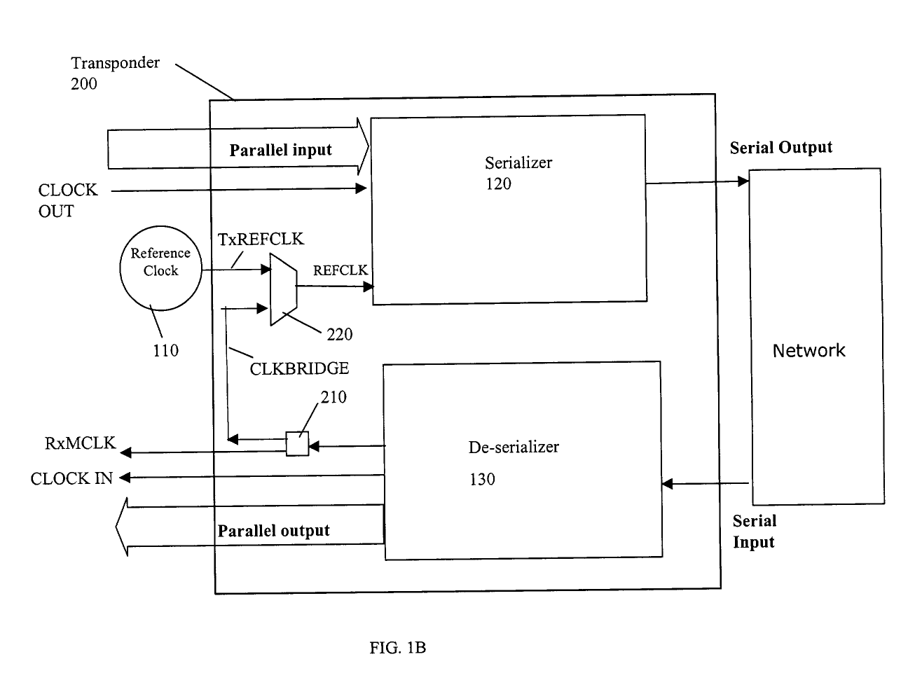

In the prior art, to provide a clock signal similar to LINETIMECLK (e.g., CLKBRIDGE in FIG. 1B), components such as splitter 210 and multiplexer 220 may be used. One advantage, although not a necessary feature, of transponder 300 is that such components may not be used. Accordingly, chipset space, power, and cost may be reduced as compared with the transponder 200 of FIG. 1B.

As depicted in FIG. 2, transponder 300 may communicate with a framer 350. For example, framer 350 may provide and receive signals to and from respective serializer 320 and de-serializer 310. Framer 350 may perform media access control (MAC) management in compliance for example with Ethernet, described for example in versions of IEEE 802.3; optical transport network (OTN) de-framing and de-wrapping in compliance for example with ITU-T G.709; forward error correction (FEC) processing, in accordance with ITU-T G.975; and/or other layer 2 processing.

For example, framer 350 may provide clock signal TXPICLK to serializer 320. For example, de-serializer 310 may provide clock signals RxMCLK and RxPOCLK to framer 350. Clock signal RxPOCLK may represent a clock signal synchronous with data transmitted by de-serializer 310 to framer 350. Clock signal TXPICLK may represent a clock signal synchronous with data transmitted from framer 350 to serializer 320. Clock signals RxPOCLK and TXPICLK may be provided for use in a system compatible with “Reference Document for a 300 Pin 10 GB Transponder” from the 10 Gbit/s MSA version 3.0 (2002).

Interface 360 may provide intercommunication between framer 350 and other devices such as a microprocessor, memory devices (not depicted), packet processor (not depicted), and/or a switch fabric (not depicted).

Intercommunication among framer 350, serializer 320, de-serializer 310, interface 360, as well as other devices that interface 360 communicates with may be achieved using interfaces compliant, for example, with Peripheral Component Interconnect (PCI), Universal Serial Bus (USB), Ethernet, IEEE 1394, 10 Gigabit Attachment Unit Interface (XAUI), Serial Peripheral Interface (SPI), ten bit interface (TBI), Gigabit Media Independent Interface (GMII) compliant interface, and/or a vendor specific multi-source agreement (MSA) protocol.

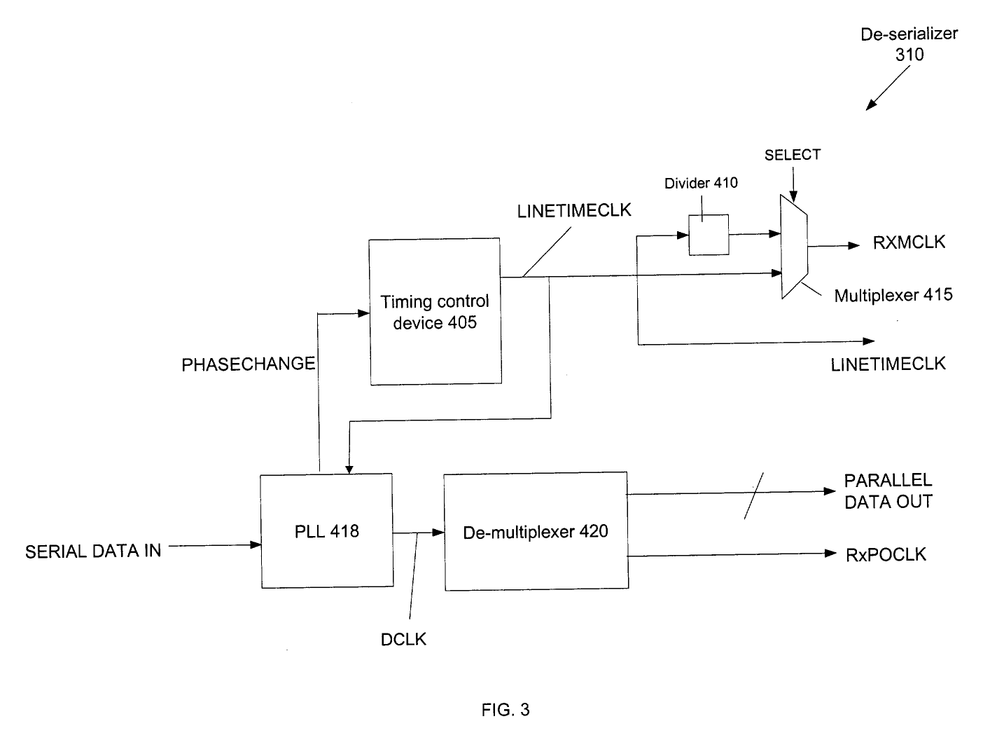

FIG. 3 depicts a suitable implementation of de-serializer 310 in block diagram format in accordance with an embodiment of the present invention. In one implementation, de-serializer 310 may include timing control device 405, frequency divider 410, multiplexer 415, phase lock loop (PLL) 418, and de-multiplexer 420.

Components of de-serializer 310 may be implemented as integrated among a single die or among several dies that intercommunicate using for example a signal conducting path of a printed circuit board or other signal transferring device.

PLL 418 may sample a serial data input (shown as SERIAL DATA IN) to determine a suitable clock signal (shown as DCLK) for use in converting a format of the serial data input from serial to parallel. For example, PLL 418 may perform oversampling on the serial data input to determine a suitable base clock signal (hereafter referred to as signal “CLK”). Signal DCLK may include signal CLK as well as other versions of signal CLK having frequency multiples of, for example, ¼, ⅛ and 1/16 of the frequency of signal CLK. The PLL 418 may compare a clock signal LINETIMECLK (from timing control device 405) with signal CLK and output a signal to the timing control device 405 to adjust the phase of clock signal LINETIMECLK (such phase control signal is shown as PHASECHANGE) to approximately match that of the clock signal CLK. PLL 418 may provide clock signal DCLK to de-multiplexer 420.

Timing control device 405 may receive signal PHASECHANGE from PLL 418. Timing control device 405 may output a clock signal LINETIMECLK to PLL 418, divider 410, and multiplexer 415. Timing control device 405 may adjust the phase of clock signal LINETIMECLK in response to signal PHASECHANGE from PLL 418. Timing control device 405 may be implemented using a voltage controlled oscillator (VCO) and clock dividers.

Frequency divider 410 may divide the frequency of clock signal LINETIMECLK by an integer, where the integer may be chosen so that a clock signal having a desired frequency is output by frequency divider 410. Frequency divider 410 may provide a frequency divided clock signal to multiplexer 415. The output of multiplexer 415 may be chosen as either the clock signal LINETIMECLK or the frequency divided clock signal (the output of multiplexer 415 is shown as signal RXMCLK). For example, signal SELECT may be used to select the output of multiplexer 415. In accordance with an embodiment of the present invention, de-serializer 310 may provide to serializer 320 a clock signal LINETIMECLK for use, for example, in “line timing mode”. In one implementation, timing control device 405 may provide a non-frequency divided version of signal LINETIMECLK as an output in addition to potentially providing a frequency divided version of signal LINETIMECLK as an output.

De-multiplexer 420 may receive clock signal DCLK from PLL 418. De-multiplexer 420 may use signal DCLK to time conversion of the format of the serial data input signal from serial to parallel. The parallel data output from de-multiplexer 420 is shown as PARALLEL DATA OUT. De-multiplexer 420 may output clock signal RxPOCLK that can be used by framer 350 to time the receipt of signal PARALLEL DATA OUT.

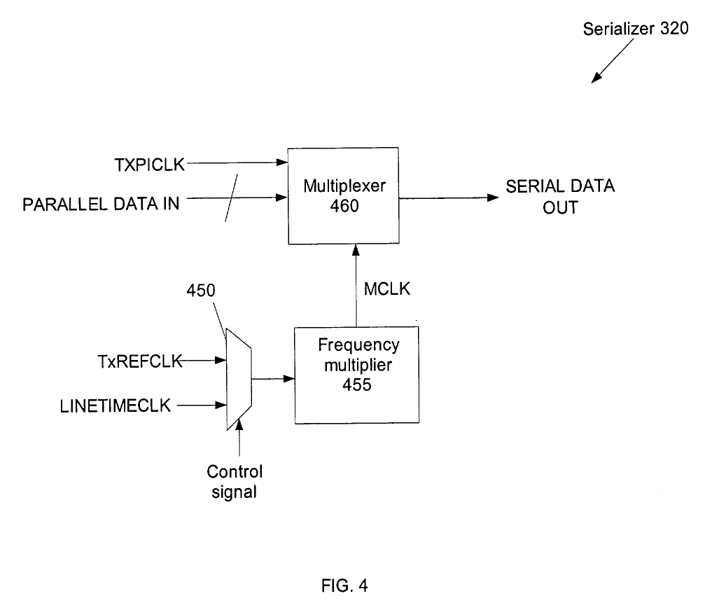

FIG. 4 depicts a suitable implementation of serializer 320 in block diagram format in accordance with an embodiment of the present invention. In one implementation, serializer 320 may include: multiplexer 450, frequency multiplier 455, and multiplexer 460. Components of serializer 320 may be implemented as integrated among a single die or among several dies that intercommunicate using for example a printed circuit board or other signal transferring device.

Multiplexer 450 may receive clock signals TxREFCLK and LINETIMECLK. For example de-serializer 310 may provide signal LINETIMECLK whereas a separate reference clock source (e.g., reference clock generator 110 of FIG. 2) may provide signal TxREFCLK. A control signal may control whether multiplexer 450 transfers TxREFCLK or LINETIMECLK to frequency multiplier 455. For example, the choice of clock signal transferred by multiplexer 450 may be based on the mode of operation (e.g., line timing or system timing).

Frequency multiplier 455 may receive a clock signal from multiplexer 450 (either TxREFCLK or LINETIMECLK). Frequency multiplier 455 may generate a clock signal (shown as MCLK) that has a frequency of some integer multiple of that of the clock signal received from multiplexer 450. Frequency multiplier 455 may output signal MCLK to multiplexer 460. For example, if MCLK is used in a system that operates in accordance with “Reference Document for a 300 Pin 10GB Transponder” from the 10 Gigabit MSA version 3.0 (2002), the frequency of MCLK may be either 16 or 64 times the frequency of the clock signal received from multiplexer 450.

Multiplexer 460 may receive data signals in parallel format (shown as PARALLEL DATA IN) as well as clock signal TXPICLK (both PARALLEL DATA IN and TXPICLK may be provided for example by framer 350). Multiplexer 460 may convert the format of such data signals from parallel to serial format. Multiplexer 460 may use signal TXPICLK to time receipt of signal PARALLEL DATA IN. Multiplexer 460 may utilize signal MCLK to time conversion of data signals to serial format.

Modifications

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. An apparatus comprising:
a serializer device comprising a multiplexer to convert an input signal format from parallel to serial format based upon a first clock signal; and
a de-serializer device comprising a clock source to provide the first clock signal and further comprising a de-multiplexer to convert serial format signals to parallel format, wherein the clock source and de-multiplexer are formed substantially within the same die.

2. The apparatus of claim 1, wherein the de-serializer device further comprises:
a phase locked loop to provide a second clock signal based upon an input data signal, wherein the de-multiplexer converts serial format signals to parallel format based upon the second clock signal.

3. The apparatus of claim 2, wherein the clock source comprises:
a timing control device to provide the first clock signal based upon the second clock signal;
a frequency divider to provide a frequency divided version of the first clock signal; and
a signal gate to selectively transfer the first clock signal or the frequency divided first clock signal.

4. The apparatus of claim 1 further comprising a signal transferring device to transfer the first clock signal to the serializer device.

5. The apparatus of claim 1, wherein the serializer device uses the first clock signal in line timing mode in accordance with Ethernet.

6. An apparatus comprising:
a serializer device comprising a multiplexer to convert an input signal format from parallel to serial format based upon a reference clock signal and further comprising a signal gate to selectively transfer a first or second clock signal, wherein the multiplexer and signal gate are formed substantially within the same die and wherein the reference clock signal is based on the transferred signal; and
a de-serializer device comprising a clock source to provide the first clock signal and further comprising a de-multiplexer to convert serial format signals to parallel format.

7. The apparatus of claim 6 further comprising a reference clock source to provide the second clock signal.

8. The apparatus of claim 6, wherein the serializer device further comprises a frequency multiplier to provide a signal having a frequency multiple of the transferred clock signal as the reference clock signal.

9. The apparatus of claim 6, wherein the de-serializer device further comprises:
a phase locked loop to provide a third clock signal based upon an input data signal, wherein the de-multiplexer converts serial format signals to parallel format based upon the third clock signal.

10. The apparatus of claim 9, wherein the clock source comprises:
a timing control device to provide the first clock signal based upon the third clock signal;
a frequency divider to provide a frequency divided version of the first clock signal; and
a signal gate to selectively transfer the first clock signal or the frequency divided first clock signal.

11. The apparatus of claim 10, wherein the clock source and de-multiplexer are formed substantially on the same die.

12. The apparatus of claim 6, wherein the clock source and de-multiplexer are formed substantially on the same die.

13. The apparatus of claim 6 further comprising a signal transferring device to transfer the first clock signal to the serializer device.

14. The apparatus of claim 6, wherein the serializer device uses the first clock signal in line timing mode in accordance with Ethernet.

15. The apparatus of claim 6, wherein the serializer device uses the second clock signal in system timing mode in accordance with SONET/SDH.

16. A system comprising:
a serializer device comprising a multiplexer to convert an input signal format from parallel to serial format based upon a reference clock signal and further comprising a signal gate to selectively transfer a first or second clock signal, wherein the multiplexer and signal gate are formed substantially within the same die and wherein the reference clock signal is based on the transferred signal;
a de-serializer device comprising a clock source to provide the first clock signal and further comprising a de-multiplexer to convert serial format signals to parallel format;
a layer 2 processor to provide parallel format data signals to the serializer device and receive parallel data signals from the de-serializer device; and
an interface device to receive and transfer information with the layer 2 processor.

17. The system of claim 16, wherein the layer two processor comprises logic to perform media access control in compliance with IEEE 802.3.

18. The system of claim 16, wherein the layer two processor comprises logic to perform optical transport network de-framing in compliance with ITU-T G.709.

19. The system of claim 16, wherein the layer two processor comprises logic to perform forward error corrections processing in compliance with ITU-T G.975.

20. The system of claim 16, further comprising a switch fabric coupled to the interface device.

21. The system of claim 16, further comprising a packet processor coupled to the interface device.
